(19) United States
(12) Patent Application Publication
(10) Pub. No.: US 2007/0288921 A1
(43) Pub. Date: Dec. 13, 2007

(54) Emulating a network-like communication connection between virtual machines on a physical device

(76) Inventors: Steven R. King, Portland, OR (US); Frank Berry, North Plains, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/452,556

(22) Filed: Jun. 13, 2006

(51) Int. Cl. G06F 9/455

(52) U.S. Cl. 718/1

(57) ABSTRACT

Methods, apparatuses, articles, and systems for facilitating network-like communication between two processes of two different virtual machines of a plurality of virtual machines operating on a common platform or physical device are described herein. In various embodiments, the physical device includes at least one sharable memory page to host an inter-domain staging buffer, and each virtual machine may include an instantiation of an inter-domain buffer manager, a data mover, an event manager and/or an inter-domain networking interface.

### TECHNICAL FIELD

Embodiments relate to the fields of data processing and data communication, in particular, to methods and apparatuses for emulating a network connection between virtual machines on a common platform or physical device, by transferring transmit data from a source process of one virtual machine on the platform/physical device to a destination process in another virtual machine on the platform/physical device, through an inter-domain staging buffer.

### BACKGROUND

Continuous advancements in virtualization and multi-processor core technology have given rise to the possibility of networking virtual machines (VM) on the same platform or physical device. However, currently, inter-VM networking communication often relies on the same protocols as communications between different physical machines on traditional networks, using communication protocols such as transmission control protocol/Internet protocol (TCP/IP). Conventional networking communication typically segments transmit data into packets, and involves several layers of addressing and encapsulation, with machine addresses and IP addresses, in addition to other information, being added to each packet sent, to facilitate routing of the packets, recovery in the event of packet loss and so forth. Much of this information is unnecessary when networking virtual machines on the same platform or physical device. Accordingly, networking virtual machines on the same platform or physical device using conventional networking communication protocols is unnecessarily burdensome and inefficient.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of various embodiments of the present invention, emulating the networking of various virtual machines on a common platform or physical device;

FIG. 2 illustrates a flow chart view of selected operations of the methods of various embodiments of the present invention, to emulate networked communication between virtual machines on a common platform or physical device;

FIG. 3 illustrates an example computer system suitable for use to practice various embodiments of the present invention.

### DETAILED DESCRIPTION OF ILLUSTRATIVE EMBODIMENTS

Illustrative embodiments of the present invention include, but are not limited to, methods and apparatuses for emulating a network connection between a first and a second virtual machine of a plurality of virtual machines, operating on the same platform or physical device. Various embodiments may include emulated establishment of a network connection, such as a remote direction memory access (RDMA) protocol connection, between the virtual machines, and emulated network transmit and receive of data between the virtual machines, by transferring transmit data between the virtual machines, using inter-domain staging buffers, and reading and writing into the inter-domain staging buffers.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The term “RDMA” is used repeatedly throughout the application. As used herein, RDMA refers to a communication technique allowing data to be transmitted directly from the memory of one computing device to another computing device without the extensive buffering and copying of the data to be transmitted that is often required by network communications.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

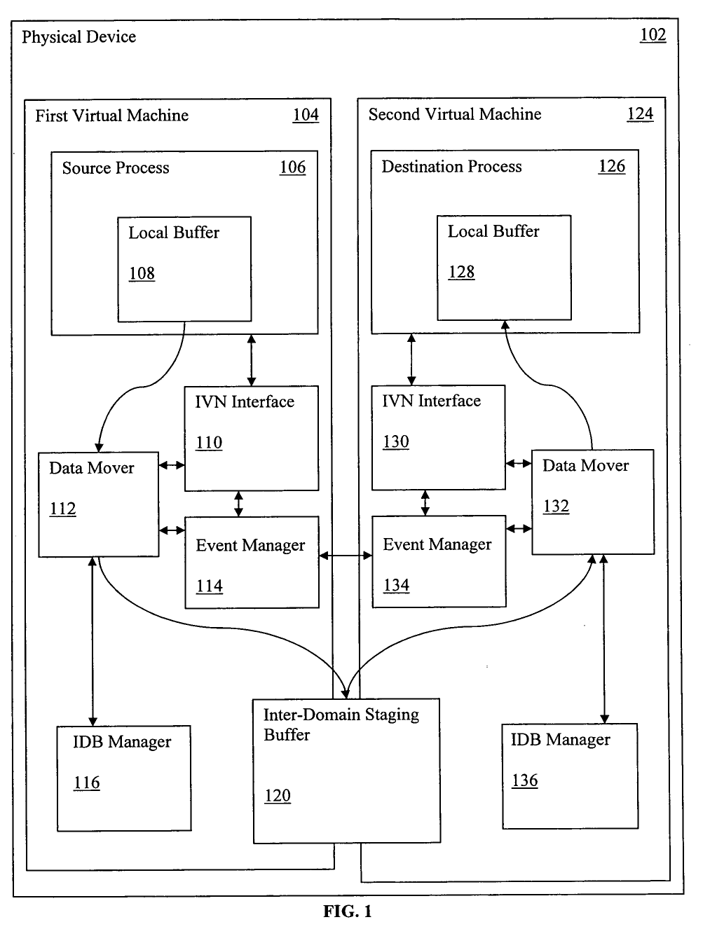

FIG. 1 illustrates an overview of various embodiments of the present invention, emulating the networking of virtual machines operating on the same platform or physical device. As illustrated, platform or physical device 102 comprises at least two virtual machines, first virtual machine 104 and second virtual machine 124. As will be described in more detail below, first and second virtual machines 104 and 124, incorporated with the teachings of embodiments of the present invention, are adapted to enable processes within the virtual machines 104 and 124 to be able to communicate with each other as if the virtual machines 104 and 124 are networked separate physical machines, but without the burden of conventional network communication. While for ease of understanding, the embodiments of the invention will be described primarily in the context of first and second virtual machines 104 and 124. The embodiments of the present invention are not so limited, and it is anticipated that the embodiments of the invention may be practiced with two or more virtual machines on a common platform or physical device (hereinafter, simply physical device).

As illustrated, first virtual machine 104 includes at least one source process 106 having at least one local buffer 108. Second virtual machine 124 includes at least destination process 126 having at least one local buffer 128. Further, to facilitate emulated networked communication in a more efficient manner, for the embodiments, both first and second virtual machines 104 and 124 also include inter-virtual machine networking (IVN) interfaces 110/130, event managers 114/134, data movers 112/132, and inter-domain buffer managers 116/136, operatively coupled to each other as shown. Additionally, the physical device 102 includes one or more inter-domain staging buffers 120 disposed, for example, in a shared memory page of physical device 102, accessible to both the first and second virtual machines 104 and 124.

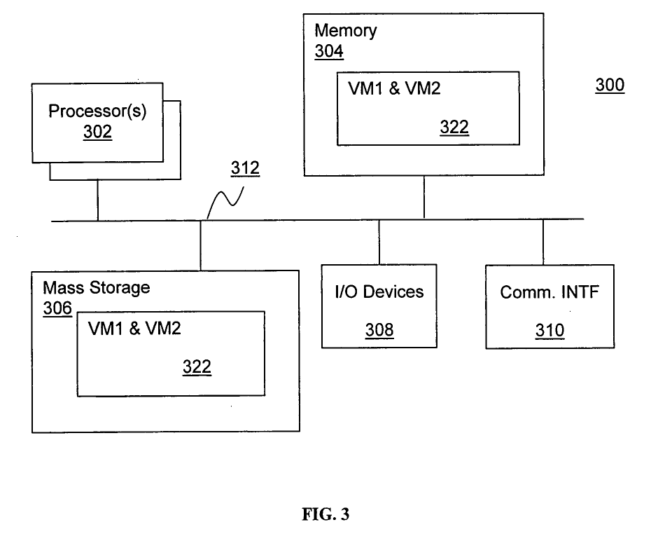

In various embodiments, physical device 102 may be any single- or multi-processor or processor core central processing unit (CPU) computing system known in the art. Physical device 102 may be a personal computer (PC), a workstation, a server, a router, a mainframe, a modular computer within a blade server or high-density server, a personal digital assistant (PDA), an entertainment center, a set-top box or a mobile device. The physical device 102 may be capable operating a plurality of operating systems of a plurality of virtual machines using virtualization technologies. If physical device 102 is a multi-processor or multi-processor core system, each virtual machine of physical device 102 may be coupled to a processor or processor core dedicated to that virtual machine. In a single processor or single processor core physical device 102, the plurality of virtual machines may share the single processor or processor core. An exemplary single-/multi-processor or processor core physical device 102 is illustrated by FIG. 3, and is described in greater detail below. Hereinafter, including in the claims, processor and processor core shall be used interchangeable, with each term including the other.

As shown and alluded earlier, physical device 102 may comprise a plurality of virtual machines, such as first virtual machine 104 and second virtual machine 124. First and second virtual machines 104 and 124, except for the teachings of embodiments of the present invention, may be any sort of virtual machines. Each of first and second virtual machines 104 and 124 may be a self-contained operating environment that behaves as if it is a separate computer system. To an outside system coupled to physical device 102 through a networking fabric, each of first and second virtual machines 104 and 124 may appear to be a separate computing device. First and second virtual machines 104 and 124 may also appear to be separate computing devices to each other, and may communicate with each other via a network-like communication connection, where each virtual machine 104/124 may send and receive data to the other, but without the burden of conventional network communication. First and second virtual machines 104 and 124 may also each have an operating system capable of managing multiple processes, such as source process 106 of first virtual machine 104, and destination process 126 of second virtual machine 124, and may each have a protected memory space that operationally belongs exclusively to that virtual machine, and one or more shared memory spaces, the shared memory spaces accessible for storing and retrieving data by more than one of the virtual machines. Suitable virtual machines and virtualization technologies include but are not limited to those available from Microsoft Corporation of Redmond, Wash., VMware, Inc. of Palo Alto, Calif., and XenSource of Cambridge, UK.

In some embodiments, physical device 102 further comprises one or more inter-domain staging buffers (hereinafter, ID buffer) 120. The ID buffer 120 may be disposed in a shared memory page of the physical device 102, and may be accessible for store and retrieve operations at the user level by virtual machines such as first and second virtual machines 104 and 124. The ID staging buffer 120 may be a reserved portion of memory, created concurrently with, prior to, or after instantiation of the first and/or second virtual machines 104 and 124.

In various embodiments, the inter-domain buffer managers (IDB managers) 116/136 of the first and second virtual machines 104 and 124 are equipped to coordinate the allocation and mapping of the ID buffers 120 of the physical device 102. In various embodiments, each of IDB Managers 116 and 136 may be equipped to create the one or more ID buffers 120 by performing a function call to its operating system service and or virtual machine manager service to allocate buffer storage in an inter-domain shared memory page. Further, each of IDB Managers 116 and 136 may be equipped to discover and map the one or more ID buffers 120 by performing a similar function call to its operating system service and or virtual machine manager service to map the allocated buffer storage in the inter-domain shared memory page.

In various embodiments, the IDB managers 116/136 may comprise independent processes of the first and second virtual machines 104 and 124, or may be sub-processes of other processes/components of the first and second virtual machines 104 and 124. In various embodiments, the IDB managers 116 and 136 are also equipped to unmap and de-allocate ID buffers 120, after data transfers (for a single or a series of transfers, e.g. of a virtual communication connection) are completed.

In various embodiments, the IVN interfaces 110/130 are adapted to facilitate emulation of establishment of networking connections, such as RDMA connections, and emulation of transmission and receipt of data between processes of the virtual machines, through the emulated connections, such as emulating RDMA transmissions and receipts through RDMA connection. More specifically, IVN interfaces 110/130 are equipped to enable source and destination processes 106 and 126 to correspondingly communicate with IVN interfaces 110/130 as if they are conventional networking interfaces. In various embodiments, IVN interfaces 110/130 are equipped to enable source and destination processes 106 and 126 to correspondingly communicate with interfaces 110/130 as if they are communicating with an RDMA verbs interface capable of establishing an RDMA connection between two ports of two systems. Rather than establishing an actual RDMA connection between two ports, however, the IVN interfaces 110/130 may establish an RDMA-like connection between a first virtual machine 104 and a second virtual machine 124 through the inter-domain staging buffer 120.

In other embodiments, the IVN interfaces 110/130 are adapted to facilitate the emulation of establishment of other network connections known in the art, and the emulation of transmission and receipt of data in accordance with the other network connections.

In various embodiments, each of IVN interfaces 110/130 is equipped to work through its corresponding event manager 114/134 to enable the other IVN interface 110/130 to emulate the networking communication with the source/destination process 106/126 on the other virtual machine 104/124. That is, each of IVN interfaces 110/130 conveys, for example, a connection request, a connection acknowledgment, and so forth, to the other IVN interface 110/130 through the event managers 114 and 134 of the two virtual machines 104 and 124.

Further, each of IVN interfaces 110/130 is equipped to work through its corresponding data mover 112/132 to write and read data into the inter-domain buffers 120 to emulate transmit and receive of transmit data from source process 106 of first virtual machine 104 to destination process 126 of second virtual machine 124. As will be described in more detail below, in various embodiments, data movers 112 and 132 further enlist the assistance of event manager 114 and 134 to effectuate the emulation of the transmit and receive.

In various embodiments, the IVN interfaces 110 and 130 may be independent processes of the first and second virtual machines 104 and 124 or sub-processes of other virtual machine processes.

As described, event managers 114/134 are equipped to assist IVN interfaces 110 and 130 in emulating networking communication for source and destination processes 106 and 126. Further, event managers 114/134 are equipped to assist IVN interfaces 110 and 130 and data movers 112 and 132 in emulating transmit and receive of transmit data from source process 106 to destination process 126. In various embodiments, the event managers 114 and 134 are adapted to communicate with each other via virtualized event channels.

In various embodiments, the event managers 114 and 134 may be independent processes of the first and second virtual machines 104 and 124 or sub-processes of other processes of virtual machines 104 and 124.

As alluded to earlier, data movers 112 and 132 are adapted to facilitate emulation of transmission of transmit data from source process 106 and receive of the transmit data by destination process 126. More specifically, as notified by IVN interface 110 of first virtual machine 104 (having been requested by source process 106 to transmit data in local buffer 108), data mover 112 retrieves the transmit data from local buffer 108 and writes the retrieved data into one or more of inter-domain staging buffers 120. In various embodiments, data mover 112 stores data into inter-domain staging buffers 120 in accordance with a networking protocol, such as the remote data memory access (RDMA) protocol or an RDMA-like protocol, which may be in byte level granularity.

In alternate embodiments, some or all of these components, i.e. inter-domain buffer manager, data mover, etc, may be combined. In other embodiments, one or more of these components may be implemented as multiple components. In still other embodiments, the invention may be practiced with other additional elements, e.g. with additional controllers in the virtual machines to complementarily control and coordinate the operations of the various components in the various virtual machines.

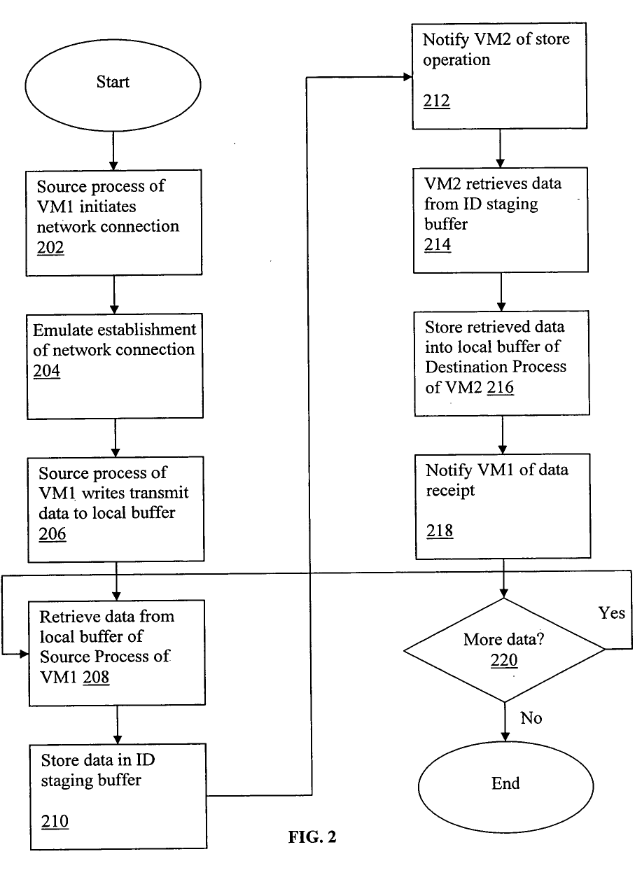

FIG. 2 illustrates a flow chart view of selected operations of the methods of various embodiments of the present invention, after various virtual machines have been initialized and one or more inter-domain buffers between the virtual machines have been created and mapped. As illustrated, a method of an embodiment may involve a source process of one virtual machine requesting a network communication connection, such as an RDMA connection, with a destination process of another virtual machine, and the establishment of the network communication connection is emulated, blocks 202-204. As discussed earlier, in various embodiments, the source process may convey the request to an IVN interface of the virtual machine, as if the source process would otherwise convey the request to a conventional networking interface. In various embodiments, the IVN interface conveys the connection request to the counterpart IVN interface in the virtual machine of the destination process. In various embodiments, the IVN interface conveys the connection requests to the counterpart IVN through the event managers of the two virtual machines.

Upon emulating the establishment of the networking communication connection, the method may continue with the source process initiating data transmission to the destination process, block 206, and the network-like transmit and receive is emulated, blocks 208-220.

More specifically, upon receiving notification from the source process, the IVN interface of the virtual machine of the source process may notify the data mover of the virtual machine of the source process to move the transmit data from the local buffer of the source process to the inter-domain buffer. In response, the data mover of the virtual machine of the source process, retrieves the transmit data from the local buffer associated with the source process, and moves all or a portion of the transmit data into the inter-domain buffer, blocks 208-210. In some embodiments, the movement of data into and/or out of the inter-domain buffer may be in accordance with a remote data memory access block that may be, for example, in byte level granularity. For the illustrated embodiments, the data mover of the virtual machine of the source process may further notify the data mover of the virtual machine of the destination process, after the transmit date (or portion thereof) has been moved, block 212. In various embodiments, the notification may be likewise accomplished through the event managers of the two virtual machines. As described earlier, in alternate embodiments, the invention may be practiced without notification with the data mover of the virtual machine checking the inter-domain buffers periodically for data newly stored therein for destination processes of its virtual machine.

Upon learning of the newly stored data, the data mover of the virtual machine of the destination process moves the data from the inter-domain buffer to the local buffer of the destination process, blocks 214-216. In various embodiments, the data mover of the virtual machine of the destination process further notifies the destination process of the arrival of the data, through the IVN of the virtual machine of the destination process, block 218. In various embodiments, the data mover of the virtual machine of the destination process may defer the notification until the entire transmit data equivalent to a unit under the conventional network communication protocol is received, or all the transmit data in association with a transmit operation are received.

Thereafter, blocks 208-218 are repeated until all transmit data are effectively “transmitted” from source process of one virtual machine to the destination process of the other virtual machine. Accordingly, transmit and receive of data between source and destination processes of virtual machines on the same physical platform or device may be emulated as conventional networking communication.

FIG. 3 illustrates an example computer system suitable for use to practice various embodiments of the present invention. As shown, computing system 400 includes one or more processors 402, and system memory 404. Additionally, computing system 400 includes mass storage devices 406 (such as diskette, hard drive, compact disc read only memory (CDROM) and so forth), input/output devices 408 (such as keyboard, cursor control and so forth) and communication interfaces 410 (such as network interface cards, modems and so forth). The elements are coupled to each other via system bus 412, which represents one or more buses. In the case of multiple buses, they are bridged by one or more bus bridges (not shown). In various embodiments, mass storage devices 406 may be divided into multiple partitions for use by the virtual machines, with each virtual machine having exclusive use of the assigned partition.

Each of these elements performs its conventional functions known in the art. In particular, system memory 404 and mass storage 406 may be employed to store a working copy and a permanent copy of the programming instructions implementing the various components of the various virtual machines, herein collectively denoted as 422. As described earlier, the various components of each virtual machine may include an inter-domain buffer manager, a data mover, an event manager, and/or an IVN interface. In various embodiments, the inter-domain buffer manager, data mover, event manager, and IVN interface may be a corresponding instance of a common domain buffer manager, a common data mover, a common event manager, and a common IVN interface of computer system 400 instantiated for the particular virtual machine. The various components may be implemented as assembler instructions supported by processor(s) 402 or high level languages, such as C, that can be compiled into such instructions.

The permanent copy of the programming instructions may be placed into permanent storage 406 in the factory, or in the field, through, for example, a distribution medium (not shown), such as a compact disc (CD), or through communication interface 410 (from a distribution server (not shown)). That is, one or more distribution medium having one or more of an implementation of the domain buffer manager, an implementation of the data mover, an implementation of the event manager, and an implementation of the IVN interface may be employed to distribute these components and program various computing devices.

The constitution of these elements 402-412 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. A method comprising:
providing an inter-domain staging buffer communicatively coupling a plurality of virtual machines to facilitate subsequent networking-like communication between a source process of a first one of the virtual machines and a destination process of a second one of the virtual machines, the first and second virtual machines operating on a same physical device; and
transmitting data from the source process of the first virtual machine to the destination process of the second virtual data machine by at least retrieving the data from a first local buffer associated with the source process and disposed within the first virtual machine, storing the retrieved data, at a user level, into the inter-domain staging buffer, retrieving the data, at the user level, from the inter-domain staging buffer, and storing the retrieved data into a second local buffer associated with the destination process and disposed within the second virtual machine.

2. The method of claim 1, wherein providing the inter-domain staging buffer further comprises creating the inter-domain staging buffer in a shared memory page of the physical device.

3. The method of claim 2, wherein said creating comprises creating the inter-domain buffer by either a first inter-domain buffer manager associated with the first virtual machine, or a second inter-domain buffer manager associated with the second virtual machine.

4. The method of claim 1, further comprises establishing a network-like communication connection between the source process and the destination process by
the source process requesting the network-like communication connection through a first inter-virtual machine networking interface of the first virtual machine, and
the first inter-virtual machine networking interface notifying the destination process of the inter-domain staging buffer and the network-like communication connection request through a second inter-virtual machine networking interface of the second virtual machine.

5. The method of claim 4, wherein establishing the network-like communication connection comprises
the first inter-virtual machine networking interface notifying the destination process of the inter-domain staging buffer and the network-like communication connection request through the second inter-virtual machine networking interface by requesting a first event manager of the first virtual machine to notify the second inter-virtual machine networking interface of the inter-domain staging buffer and the network-like communication connection request, and
the first event manager notifying the second inter-virtual machine networking interface of the inter-domain staging buffer and the network-like communication connection request through a second event manager of the second virtual machine.

6. The method of claim 5, wherein said notifying comprises the first event manager notifying the second event manager of the inter-domain staging buffer and the network-like communication connection request through a virtual event channel between the first and second event managers.

7. The method of claim 1, wherein
said retrieving of the data from the first local buffer and storing of the retrieved data, at the user level, into the inter-domain staging buffer comprises retrieving the data from the first local buffer by a first data mover associated with the first virtual machine, and writing the retrieved data, at the user level, into the inter-domain staging buffer by the first data mover; and
said retrieving of the data, at the user level, from the inter-domain staging buffer and storing of the retrieved data into the second local buffer comprises retrieving the data, at the user level, from the inter-domain staging buffer by a second data mover associated with the second virtual machine, and writing the retrieved data into the second local buffer by the second data mover.

8. The method of claim 1, wherein said retrieving of the data from the first local buffer and storing of the retrieved data, at the user level, into the inter-domain staging buffer comprises retrieving the data from the first local buffer by a data mover associated with the first virtual machine, and writing the retrieved data, at the user level, into the inter-domain staging buffer by the data mover.

9. The method of claim 8, further comprising the first data mover notifying the second data mover of the data or a portion thereof having been stored in the inter-domain staging buffer.

10. The method of claim 9, wherein the first data mover notifies the second data mover through a first event manager associated with the first virtual machine, which in turn, notifies the second data mover through a second event manager associated with the second virtual machine.

11. The method of claim 8, further comprising the second data mover periodically checking the inter-domain staging buffer for data newly stored into the inter-domain staging buffer for the destination process.

12. The method of claim 1, wherein said retrieving of the data, at the user level, from the inter-domain staging buffer and storing of the retrieved data into the second local buffer comprises retrieving the data, at the user level, from the inter-domain staging buffer by a data mover associated with the second virtual machine, and writing the retrieved data into the second local buffer by the data mover.

13. The method of claim 1, wherein the data transmitted from the source process to the destination process through the inter-domain staging buffer is transferred at a byte granularity.

14. A computing device comprising:
one or more processors;
at least one sharable memory page capable of hosting an inter-domain staging buffer for facilitating network-like communication between two processes of two different virtual machines of a plurality of virtual machines operated by the one or more processors; and
an inter-domain buffer manager instantiable into a first inter-domain buffer manager instance within a first virtual machine operated by one of the one or more processors to manage allocation and mapping of the inter-domain staging buffer for the first virtual machine, and into a second inter-domain buffer manager instance within a second virtual machine operated by one of the one or more processors to manage allocation and mapping of the inter-domain staging buffer for the second virtual machine.

15. The computing device of claim 14, further comprising a data mover instantiable into a first data mover instance within the first virtual machine to move data, at a user level, from a first local buffer associated with a source process of the first virtual machine, into the inter-domain staging buffer, and into a second data mover instance within the second virtual machine to move the data, at the user level, from the inter-domain staging buffer to a second local buffer associated with a destination process of the second virtual machine.

16. The computing device of claim 15, wherein the data mover is further adapted to periodically check the inter-domain buffer for newly stored data for the destination process of the second virtual machine, when operating as the second data mover instance.

17. The computing device of claim 15, wherein the data mover is further adapted to cause a notification of the storing of the data into the inter-domain staging buffer to be given to the second data mover instance, after the storing, when operating as the first data mover instance.

18. The computing device of claim 17, further comprising an event manager instantiable into a first and a second event manager instance within the first and the second virtual machines, respectively, to assist the first data mover instance in notifying the second data mover of the storing, the first event manager instance notifying the second data mover instance through the second event manager instance.

19. The computing device of claim 18, wherein the first event data manager instance notifies the second event data manager of the storing through a virtual even channel.

20. The computing device of claim 15, further comprising an inter-virtual machine networking interface instantiable into a first and a second inter-virtual machine networking interface instance within the first and the second virtual machine, respectively, to facilitate the source process in transmitting data to the destination process in a network-like manner, the source process requesting the first data mover, through the first inter-virtual machine interface instance, to store the data the source process has to transmit in the inter-domain staging buffer, the first data mover notifying the second data mover of the storing of the data into the inter-domain staging buffer, after moving the data into the inter-domain staging buffer, and the second data mover notifying the destination process of having received the data, through the second inter-virtual machine interface instance.

21. The computing device of claim 14, further comprising an inter-virtual machine networking interface instantiable into a first and a second inter-virtual machine networking interface instance within the first and the second virtual machine, respectively, to facilitate the source process in communicating with the destination process in a network-like manner, including the source process requesting a network communication connection with the destination process.

22. The computing device of claim 21, further comprising an event manager instantiable into a first and a second event manager instance within the first and the second virtual machines, respectively, to assist the first and second inter-virtual machine instances in facilitating the source process to communicate with the destination process in a network-like manner, the first inter-virtual machine interface instance assisting the source process in requesting a network-like communication connection with the destination process through the first event manager instance, which in turn, relays the request to the destination process through second event manager instance and the second inter-virtual machine interface instance.

23. An article of manufacture comprising:
a storage medium; and
at least a selected one of first, second, third, and fourth programming instructions, the selected programming instructions being stored in the storage medium, wherein
the first programming instructions implementing an inter-domain buffer manager instantiable within a virtual machine to manage allocation and mapping of an inter-domain staging buffer for the virtual machine;
the second programming instructions implementing a data mover instantiable within the virtual machine to
move data, at a user level, from a local buffer associated with a source process of the virtual machine into the inter-domain staging buffer, and/or
move data, at the user level, from the inter-domain staging buffer into a local buffer associated with a destination process of the virtual machine;
the third programming instructions implementing an event manager instantiable within the virtual machine to assist in notifying another virtual machine of events;
the fourth programming instructions implementing a inter-virtual machine interface instantiable within the virtual machine to facilitate network-like communication by either the source or destination process of the virtual machine with another destination or source process of another virtual machine.

24. The article of manufacture of claim 23, wherein the article comprises at least two selected from the group of the first, second, third and fourth programming instructions.

25. A system comprising:
one or more processors;
volatile memory coupled to the one or more processors, including at least one sharable memory page capable of hosting an inter-domain staging buffer for facilitating network-like communication between two processes of two different virtual machines operated by the one or more processors; and
a mass storage coupled to the one or more processors, and having stored therein a data mover instantiable into a first data mover instance within a first virtual machine operated by one of the one or more processors to move data, at a user level, from a first local buffer associated with a source process of the first virtual machine, into the inter-domain staging buffer, and into a second data mover instance within a second virtual machine operated by one of the one or more processors to move the data, at the user level, from the inter-domain staging buffer to a second local buffer associated with a destination process of the second virtual machine.

26. The system of claim 25, wherein the data mover is further adapted to periodically check the inter-domain staging buffer for newly stored data for the destination process of the second virtual machine, when operating as the second data mover instance.

27. The system of claim 25, wherein the data mover is further adapted to cause a notification of the storing of the data into the inter-domain staging buffer to be given to the second data mover instance, after the storing, when operating as the first data mover instance.

28. The system of claim 27, further comprising an event manager instantiable into a first and a second event manager instance within the first and the second virtual machines, respectively, to assist the first data mover instance in notifying the second data mover of the storing, the first event manager instance notifying the second data mover instance through the second event manager instance.

29. The system of claim 28, wherein the first event data manager instance notifies the second event data manager of the storing through a virtual even channel.

30. The system of claim 25 further comprising an inter-virtual machine networking interface instantiable into a first and a second inter-virtual machine networking interface instance within the first and the second virtual machine, respectively, to facilitate the source process in transmitting data to the destination process in a network-like manner, the source process requesting the first data mover, through the first inter-virtual machine interface instance, to store the data the source process has to transmit in the inter-domain staging buffer, the first data mover notifying the second data mover of the storing of the data into the inter-domain staging buffer, after moving the data into the inter-domain staging buffer, and the second data mover notifying the destination process of having received the data, through the second inter-virtual machine interface instance.
